(19) United States
(12) Patent Application Publication
(10) Pub. No.: US 2025/0350136 A1
(43) Pub. Date: Nov. 13, 2025

(54) CHARGING SYSTEM AND METHOD

(71) Applicant: Cypress Semiconductor Corporation, San Jose, CA (US)

(72) Inventors: Muthukrishnan HARIRAMA GURUDEVARAJU, Bangalore (IN); Ajeethkumar P, Coimbatore (IN); Milind DIGHRASKER, Bangalore (IN)

(73) Assignee: Cypress Semiconductor Corporation, San Jose, CA (US)

(21) Appl. No.: 18/662,855

(22) Filed: May 13, 2024

(51) Int. Cl. H02J 7/00; H02J 50/10

(52) U.S. Cl. CPC H02J 7/00712; H02J 7/0042; H02J 7/0048; H02J 50/10

(57) ABSTRACT

In an embodiment of the techniques presented herein, a charging system includes an output port configured to operate as a Universal Serial Bus Power Delivery (USB-PD) port, a wireless charging unit having a magnetic charging interface that conforms to a wireless charging protocol, a voltage regulator circuit, a switch configurable to connect the voltage regulator circuit to the output port or the wireless charging unit, and a charging integrated circuit (IC) controller configured to control the switch to connect the voltage regulator circuit to the wireless charging unit and control the voltage regulator circuit to generate a magnetic charging signal at the magnetic charging interface based on a connection state of the magnetic charging interface, and connect the voltage regulator circuit to the output port and control the voltage regulator circuit to generate a charging signal at the output port based on a connection state of the output port.

### BACKGROUND

Various electronic devices (e.g., such as smartphones, tablets, notebook computers, laptop computers, hubs, chargers, adapters, etc.) are configured to transfer power through Universal Serial Bus (USB) connectors according to USB power delivery protocols defined in various revisions of the USB Power Delivery (USB-PD) specification, such as USB Type-C or legacy USB specifications such as Type-A or Type-B. Some devices also support wireless charging defined in various specifications.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

According to one or more of the aspects presented herein, a charging system comprises an output port configured to operate as a Universal Serial Bus Power Delivery (USB-PD) port, a wireless charging unit comprising a magnetic charging interface that conforms to a wireless charging protocol, a voltage regulator circuit, a switch configurable to connect the voltage regulator circuit to the output port or the wireless charging unit, and a charging integrated circuit (IC) controller configured to control the switch to connect the voltage regulator circuit to the wireless charging unit and control the voltage regulator circuit to generate a magnetic charging signal at the magnetic charging interface based on a connection state of the magnetic charging interface, and control the switch to connect the voltage regulator circuit to the output port and control the voltage regulator circuit to generate a charging signal at the output port based on a connection state of the output port.

According to one or more of the aspects presented herein, a method for operating a charging system comprises controlling, by an integrated circuit (IC) controller of the charging system, a switch to connect a voltage regulator circuit of the charging system to one of an output port of the charging system or a magnetic charging interface of a wireless charging unit of the charging system based on a connection state of the output port and a connection state of the magnetic charging interface, wherein the output port is a Universal Serial Bus Power Delivery (USB-PD) port and the magnetic charging interface conforms to a wireless charging protocol, controlling, by the IC controller, the voltage regulator circuit to generate a magnetic charging signal at the magnetic charging interface responsive to the switch being controlled to connect the voltage regulator circuit to the magnetic charging unit, and controlling, by the IC controller, the voltage regulator circuit to generate a charging signal at the output port responsive to the switch being controlled to connect the voltage regulator circuit to the output port.

According to one or more of the aspects presented herein, a charging system comprises an output port configured as a Universal Serial Bus Power Delivery (USB-PD) port, a voltage regulator circuit, a wireless charging unit configured according to a wireless charging protocol, the wireless charging unit comprising an inverter connected to the voltage regulator circuit, and a magnetic charging interface, and a charging integrated circuit (IC) controller configured to control the voltage regulator circuit to generate a charging signal at the output port based on a connection state of the output port, and control the inverter to generate a magnetic charging signal at the magnetic charging interface based on a connection state of the magnetic charging interface.

According to one or more of the aspects presented herein, a system for operating a charging system comprises means for controlling, by an integrated circuit (IC) controller of the charging system, a switch to connect a voltage regulator circuit of the charging system to one of an output port of the charging system or a magnetic charging interface of a wireless charging unit of the charging system based on a connection state of the output port and a connection state of the magnetic charging interface, wherein the output port is a Universal Serial Bus Power Delivery (USB-PD) port and the magnetic charging interface conforms to a wireless charging protocol, means for controlling, by the IC controller, the voltage regulator circuit to generate a magnetic charging signal at the magnetic charging interface responsive to the switch being controlled to connect the voltage regulator circuit to the magnetic charging unit, and means for controlling, by the IC controller, the voltage regulator circuit to generate a charging signal at the output port responsive to the switch being controlled to connect the voltage regulator circuit to the output port.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a block diagram illustrating a charging system with load selection, in accordance with some embodiments.

FIG. 2 is a flowchart illustrating a method of operating a charging system with load selection, in accordance with some embodiments.

FIG. 3 is a block diagram illustrating a charging system with load sharing, in accordance with some embodiments.

FIG. 4 is a flowchart illustrating a method of operating a charging system with load sharing, in accordance with some embodiments.

FIG. 5 illustrates an exemplary embodiment of a system, in accordance with some embodiments.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

It is to be understood that the following description of embodiments is not to be taken in a limiting sense. The scope of the present disclosure is not intended to be limited by the embodiments described hereinafter or by the drawings, which are taken to be illustrative only. The drawings are to be regarded as being schematic representations and elements illustrated in the drawings are not necessarily shown to scale. Rather, the various elements are represented such that their function and general purpose become apparent to a person skilled in the art.

All numerical values within the detailed description and the claims herein are modified by “about” or “approximately” the indicated value, and take into account experimental error and variations that would be expected by a person having ordinary skill in the art.

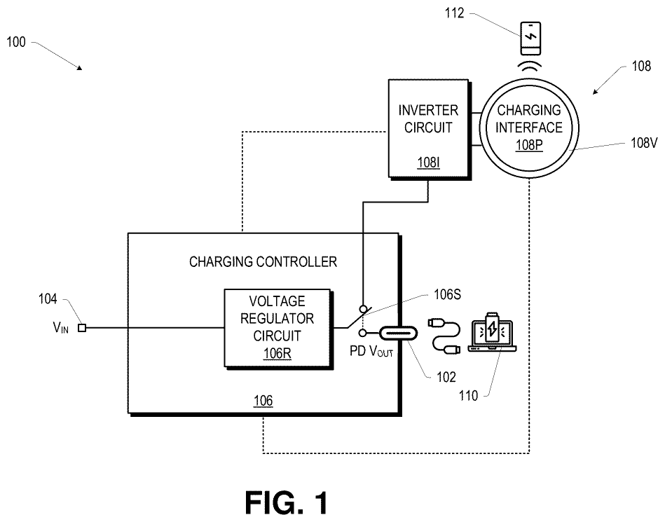

FIG. 1 is a block diagram illustrating a charging system 100 with load selection, in accordance with some embodiments. The charging system 100 includes a universal serial bus power delivery (USB-PD) port 102 (e.g., which conforms to a USB-PD protocol), a voltage input port 104, and a charging controller 106 comprising a voltage regulator circuit 106R and a switch 106S, a wireless charging unit 108 comprising an inverter circuit 1081 and a magnetic charging interface 108P conforming to a wireless charging protocol (e.g., such as wireless charging transmitter, TX, conforming to the Qi2 wireless charging protocol). The magnetic charging interface 108P may be a charging pad, a magnetic beamforming device, or some other type of magnetic charging interface. In some embodiments, the voltage regulator circuit 106R and the switch 106S are integrated into the charging controller 106, for example, in the same integrated circuit (IC) package. Alternatively, one or both of the voltage regulator circuit 106R or the switch 106S may be external to the charging controller 106. In some embodiments, the charging system 100 receives an input voltage, VIN, at the voltage input port 104. In some embodiments, the voltage input port 104 is connected to a DC voltage supply, such as a battery (e.g., in a vehicle). In some embodiments, the voltage input port 104 comprises a USB port (e.g., such as a USB Type-C port) that may be connected to a USB-PD adaptor that generates a DC voltage from an AC power source. In some embodiments, the charging system 100 may be integrated into a housing that includes the magnetic charging interface 108P.

The USB port 102 provides an output voltage, PD V_{OUT}, to a connected USB-PD device 110, such as a laptop, a smart phone, a tablet, or some other device, which may include a rechargeable battery or which may consume power directly from the USB port 102 (e.g., a flashlight). The charging controller 106 controls the voltage regulator circuit 106R to deliver power to the USB port 102 from the input voltage, VIN, received at the input port 104 according to a negotiated power delivery contract. The inverter circuit 1081 generates an AC voltage from the DC voltage generated by the voltage regulator circuit 106R for powering a coil circuit in the magnetic charging interface 108P to generate a magnetic signal for charging (through a wireless charging receiver, RX) a device 112, such as a laptop, a smart phone, a tablet, or some other device, which may include a rechargeable battery or consume power directly from the wireless charging receiver.

In some embodiments, the charging controller 106 configures the switch 106S to selectively route the output of the voltage regulator circuit 106R to the USB port 102 or to the wireless charging unit 108 depending on whether the USB-PD device 110 is connected to the USB port 102 or the wireless charging device 112 is interfaced with the magnetic charging interface 108P. In some embodiments, the charging controller 106 configures the switch 106A to charge the first device connected to the charging system. To connect a second device the first device would need to be disconnected by disconnecting the USB-PD device 110 from the USB port 102 or by removing the wireless charging device 112 from the magnetic charging interface 108P.

The charging controller 106 controls the voltage regulator circuit 106R to generate a DC voltage from the input voltage, VIN, voltage received at the input port 104. If the input voltage, VIN, is higher than the voltage required by the USB port 102 or the wireless charging unit 108, the charging controller 106 operates the voltage regulator circuit 106R in a buck mode to reduce the voltage. If the input voltage, VIN, is lower than the voltage required by the USB port 102 or the wireless charging unit 108, the charging controller 106 operates the voltage regulator circuit 106R in a boost mode to increase the voltage. If the input voltage, VIN, equals the voltage required by the USB port 102 or the wireless charging unit 108, the charging controller 106 operates the voltage regulator circuit 106R in a unity gain mode.

In some embodiments, the magnetic charging interface 108P comprises a visual indicator 108V, such as a circular LED, that indicates the charging status of the magnetic charging interface 108P. The charging controller 106 changes the state of the visual indicator 108V depending on the configuration of the switch 106S. For example, the visual indicator 108V may be red if the switch 106S is configured to charge the USB-PD device 110 at the USB port 102 or the visual indicator 108V may be green if the switch 106S is configured to charge the wireless charging device 112. The visual indicator 108V allows the user to readily determine the charging mode and disconnect a device if a mode change is desired.

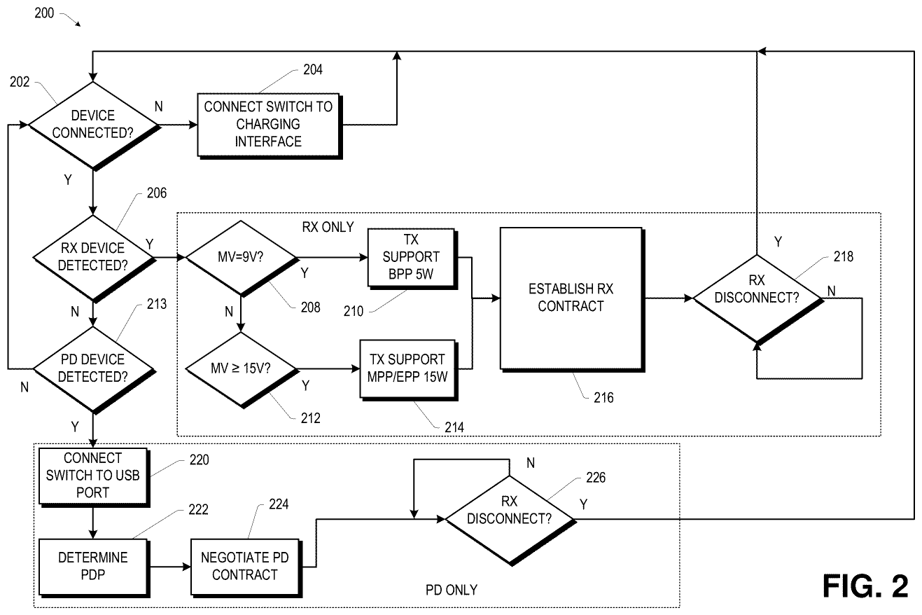

FIG. 2 is a flowchart illustrating a method 200 of operating the charging system 100 with load selection, in accordance with some embodiments. At 202, the charging controller 106 determines if any devices are connected (e.g., the USB-PD device 110 or the wireless charging device 112). In some embodiments, the charging controller 106 identifies if the wireless charging device 112 is connected based on the connection state of the magnetic charging interface 108P and the charging controller 106 determines if the USP-PD device 110 is connected based on the connection state of the USB port 102. If no device 110, 112 is connected to the charging system 100 at 202, the charging controller 106 connects the switch to the magnetic charging interface 108P and establishes a magnetic signal to allow detection of a subsequent connection of the wireless charging device 112. The charging controller 106 may detect a connection of the USB-PD device 110 at the USB port 102 based on the signals on the configuration channel (CC) pins even if power is not being delivered to the USB port 102 by the voltage regulator circuit 106C.

If a wireless charging device 112 is connected at 206, the charging controller 106 determines the maximum voltage (MV) supported by the charging controller 106 for the wireless charging unit 108. Initially, the charging controller 106 enables the wireless charging unit 108 and waits for a connection with the wireless charging device 112 to be detected. If a connection with the wireless charging device 112 is detected, the voltage is changed to 9V (Vin) and a digital pin is used for communication with the wireless charging device 112. Based on a configuration parameter (ID/XID) provided by the wireless charging device 112, the capability of the wireless charging device 112 is determined, such as a baseband power profile (BPP) of 5 W, or higher power profile of 15 W, such as a magnetic power profile (MPP) or an extended power profile (EPP). Based on the Rx requirement, the charging controller 106 configures the voltage regulator circuit 106R in a buck mode or a boost mode. The charging controller 106 configures a BPP profile at 210 if the MV voltage is 9V at 208 or a MPP at 214 if the MV is greater than or equal to 15V at 212. If the wireless charging device 112 is disconnected at 218, the charging controller 106 returns to 202 to detect a subsequent device connection.

If the connected device at 202 is determined to be the USP-PD device 110 at 213, the charging controller 106 configures the switch 106S to connect the voltage regulator circuit 106R to the USB port 102 at 220. At 222, the charging controller 106 determines a power delivery profile (PDP) depending on the amount of power available for the USB port 102, for example, up to 100 W, 20V, 5 A, or some other power level depending on a power limit that may be established for the source providing power to the input port 104. An example PDP may include fixed power delivery objects (PDOs) such as 20V @ 2.25 A=45 W, 15V @ 3 A=45 W, 9V @ 3 A=27 W, 5V @ 3 A=15 W or programmable power supply (PPS) augmented PDOs (APDOs), such as 5V˜15V at 3 A=15 W−45 W; 20V at 3 A or 5 A=60 W or 100 W. The PDP specifies various voltage levels and current levels supported by the charging controller 106 to establish a PD contract with the USP-PD device 110. At 224, the charging controller 106 negotiates with the USP-PD device 110 to establish a PD contract based on the PDP. The charging controller 106 detects a disconnection of the USP-PD device 110 from the USB port 102 at 226. Responsive to the disconnection, the charging controller 106 returns to 202 to detect a subsequent device connection.

In some embodiments, the charging controller 106 operates the charging system 100 is a load sharing arrangement. To enable load sharing, the switch 106S is configured to connect the voltage regulator circuit 106R to the USB port 102 and the inverter circuit 1081, as represented by the dashed line at the output of the switch 106S in FIG. 1. To facilitate this connection, the switch 106S may have two switch elements, such as a first switch element connected between the voltage regulator circuit 106R and the inverter circuit 1081 and a second switch element connected between the voltage regulator circuit 106R and the USB port 102. If load sharing is enabled, both switch elements are closed. The visual indicator 108V may be red if the device on the magnetic charging interface 108P is not chargeable, yellow if the wireless charging unit 108 can only be operated in restricted mode (e.g., 5 W), and green if the wireless charging unit 108 can be operated in full mode (e.g., 15 W). The visual indicator 108V allows the user to readily determine the charging mode.

In a load sharing mode, the charging controller 106 operates the voltage regulator circuit to provide the output voltage, PD V_{OUT}, according to the PD contract with the USP-PD device 110. If the requested voltage for PD V_{OUT} is at least 9V and at least 5 W of additional power is available after fulfilling the PD contract, the charging controller 106 can support wireless charging in reduced mode. If the requested voltage for PD V_{OUT} is at least 15V and at least 15 W of additional power is available after fulfilling the PD contract, the charging controller 106 can support wireless charging in full mode. In load sharing mode, the input to the inverter circuit 1081 is a fixed voltage, and the charging controller 106 controls the switching frequency of the inverter 1061 to generate the magnetic signal for the magnetic charging interface 108P to deliver power to the wireless charging device 112 in reduced or full mode.

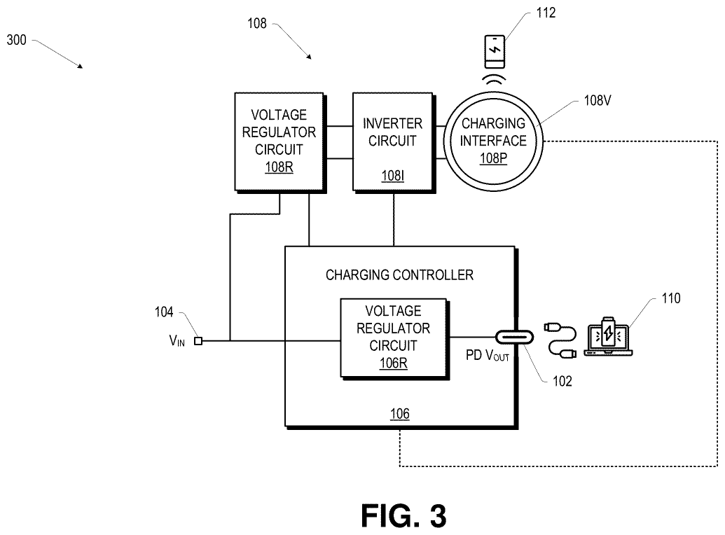

FIG. 3 is a block diagram illustrating a charging system 300 with load sharing, in accordance with some embodiments. Elements corresponding to those of FIG. 1 have the same reference numbers. The charging system 300 includes a universal serial bus (USB) port 102, a voltage input port 104, and a charging controller 106 comprising a voltage regulator circuit 106R, a wireless charging unit 108 comprising a voltage regulator circuit 108R, an inverter circuit 1081, and a magnetic charging interface 108P. In some embodiments, the voltage regulator circuit 106R is integrated into the charging controller 106, for example, in the same integrated circuit (IC) package. Alternatively, the voltage regulator circuit 106R may be external to the charging controller 106. In some embodiments, the charging system 300 receives an input voltage, VIN, at the voltage input port 104. In some embodiments, the voltage input port 104 is connected to a DC voltage supply, such as a battery (e.g., in a vehicle). In some embodiments, the voltage input port 104 comprises a USB port (e.g., such as USB-C port) that may be connected to a USB-PD adaptor that generates a DC voltage from an AC power source. In some embodiments, the charging system 100 may be integrated into a housing that includes the magnetic charging interface 108P.

The USB port 102 provides an output voltage, PD V_{OUT}, to a connected USB-PD device 110, such as a laptop, a smart phone, a tablet, or some other device. The charging controller 106 controls the voltage regulator circuit 106R to deliver power to the USB port 102 from the input voltage, VIN, received at the input port 104 according to a negotiated power delivery contract. The charging controller 106 controls the voltage regulator circuit 108R to deliver power to the inverter circuit 1081 from the input voltage, VIN, voltage received at the input port 104. The inverter circuit 1081 generates an AC voltage from the DC voltage generated by the voltage regulator circuit 108R for powering a coil circuit in the magnetic charging interface 108P to generate a magnetic signal for charging a wireless charging device 112, such as a laptop, a smart phone, a tablet, or some other device, typically including a rechargeable battery.

In some embodiments, the charging controller 106 supports power sharing between the USB port 102 and the magnetic charging interface 108P. If the wireless charging device 112 is interfaced with the magnetic charging interface 108P, the charging controller 106 allocates remaining power to the PDP for powering the USB-PD device 110 connected to the USB port 102. The PDP specifies various voltage levels and current levels supported by the charging controller 106 to establish a PD contract with the USP-PD device 110.

If the input voltage, VIN, is higher than the voltage required by the USB port 102 or the wireless charging unit 108, the charging controller 106 operates the associated voltage regulator circuit 106R, 108R in a buck mode to reduce the voltage. If the input voltage, VIN, is lower than the voltage required by the USB port 102 or the wireless charging unit 108, the charging controller 106 operates the associated voltage regulator circuit 106R, 108R in a boost mode to increase the voltage. If the input voltage, VIN, equals the voltage required by the USB port 102 or the wireless charging unit 108, the charging controller 106 operates the associated voltage regulator circuit 106R, 108R in a unity gain mode. The voltage regulator circuits 106R, 108R may be operated in different modes.

In some embodiments, the magnetic charging interface 108P comprises a visual indicator 108V, such as a circular LED, that indicates the charging status of the magnetic charging interface 108P. The visual indicator 108V may be red if the device on the magnetic charging interface 108P is not chargeable, yellow if the wireless charging unit 108 can be operated in restricted mode (e.g., 5 W), and green if the wireless charging unit 108 can be operated in full mode (e.g., 15 W). The visual indicator 108V allows the user to readily determine the charging mode.

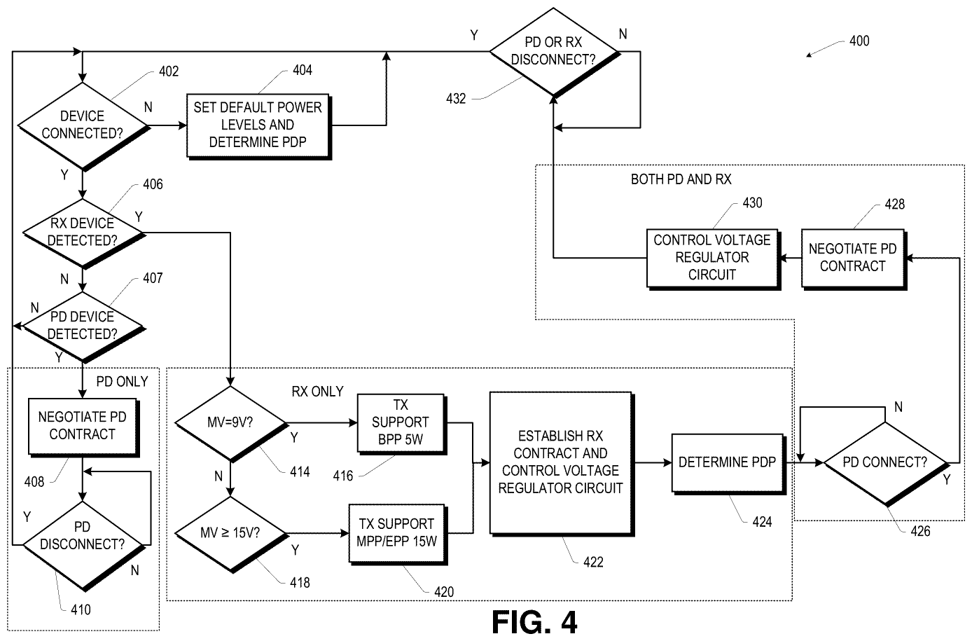

FIG. 4 is a flowchart illustrating a method 400 of operating a charging system 100, 300 with load sharing, in accordance with some embodiments. At 402 the charging controller 106 determines if any devices are connected (e.g., the USP-PD device 110 or the wireless charging device 112). In some embodiments, the charging controller 106 identifies if the wireless charging device 112 is connected based on the connection state of the magnetic charging interface 108P and the charging controller 106 determines if the USP-PD device 110 is connected based on the signals on the configuration channel (CC) pins of the USB port 102. If no device is connected to the charging system 100, 300 at 402, the charging controller 106 sets default levels for the voltage regulator circuit 106R or the voltage regulator circuit 108R (for the charging system 300) and generates a PDP for the power remaining after powering the wireless charging unit 108 at 404.

If a wireless charging device 112 is not connected at 406 the charging controller 106 determines if the USP-PD device 110 is connected at 407. If the USP-PD device 110 is connected at 407, the charging controller 106 negotiates a PD contract with the USP-PD device 110 at 408 based on the PDP determined at 404, otherwise the charging controller 106 returns to 402. The charging controller 106 detects a disconnection of the USP-PD device 110 from the USB port 102 at 410. Responsive to the disconnection at 410, the charging controller 106 returns to 402 to return to the default state. The charging controller 106 may transition to 406 if the wireless charging device 112 is connected prior to detecting the PD disconnect at 410.

If the wireless charging device 112 is connected at 406, the charging controller 106 determines the maximum voltage (MV) for wireless charging unit 108. Initially, the charging controller 106 enables the wireless charging unit 108 and waits for a connection with the wireless charging device 112 to be detected. If a connection with the wireless charging device 112 is detected, the voltage is changed to 9V (Vin) and a digital pin is used for communication with the wireless charging device 112. Based on a configuration parameter (ID/XID) provided by the wireless charging device 112, the capability of the wireless charging device 112 is determined, such as a BPP of 5 W or higher power profile of 15 W, such as an MPP or an EPP. Based on the Rx requirement, the charging controller 106 configures the voltage regulator circuit 106R in a buck mode or a boost mode. The charging controller 106 configures a BPP profile at 416 if the MV voltage is 9V at 414 (e.g., restricted mode with yellow visual indicator 108V) or a MPP at 420 (e.g., full mode with green visual indicator 108V). if the MV is greater than or equal to 15V at 418 based on the TX profile set at 416 or 420, the charging controller 106 establishes a RX contract with the wireless charging device 112 and controls the voltage regulator circuit 106R for the charging system 100 or controls the voltage regulator circuit 108R for the charging system 300 according to the selected MV at 422. At 424, the charging controller 106 determines a PDP based on the remaining power available if the USP-PD device 110 were to be connected. For example, the power available for allocation by the charging controller 106 would be the power available at the input port 104 minus a first portion of the available power allocated to the charging controller 106 for the wireless charging unit 108. The PDP specifies various voltage levels and current levels supported by the charging controller 106 to establish a contract with the USP-PD device 110.

The charging controller detects a connection of a USP-PD device 110 at 426 (i.e., both USP-PD device 110 and wireless charging device 112 are connected). The charging controller 106 negotiates a PD contract with the USP-PD device 110 based on the PDP at 428 and controls the voltage regulator circuit 106R according the power delivery contract at 430 to provide power to the USB port 102 and controls the inverter circuit 1081 for the charging system 100 or the voltage regulator circuit 108R for the charging system 300 to power the inverter circuit 1081.

The charging controller 106 detects a disconnection of the USP-PD device 110 from the USB port 102 or the disconnection of the charging device 112 from the wireless charging unit 108 at 432. Responsive to the disconnection at 432, the charging controller 106 returns to 402. The charging controller 106 dynamically updates the PDP as connection states change for the wireless charging device 112 or the USP-PD device 110.

If the charging controller 106 has already established a PD contract with the USP-PD device 110 at 408 and the wireless charging device 112 is subsequently connected with the method 400 transitioning to 406, preference may be given to the USP-PD device 110 and the restricted mode may be set at 414 and 416 if sufficient voltage (PD V_{OUT}) or power is not available to support the PD contract and full mode wireless charging. If power remaining after fulfilling the PD contract is not sufficient, the charging controller 106 may disable wireless charging. Alternatively, preference may be given to the wireless charging device 112 to provide full mode wireless charging and the PDP may be updated and the PD contract renegotiated for the USP-PD device 110.

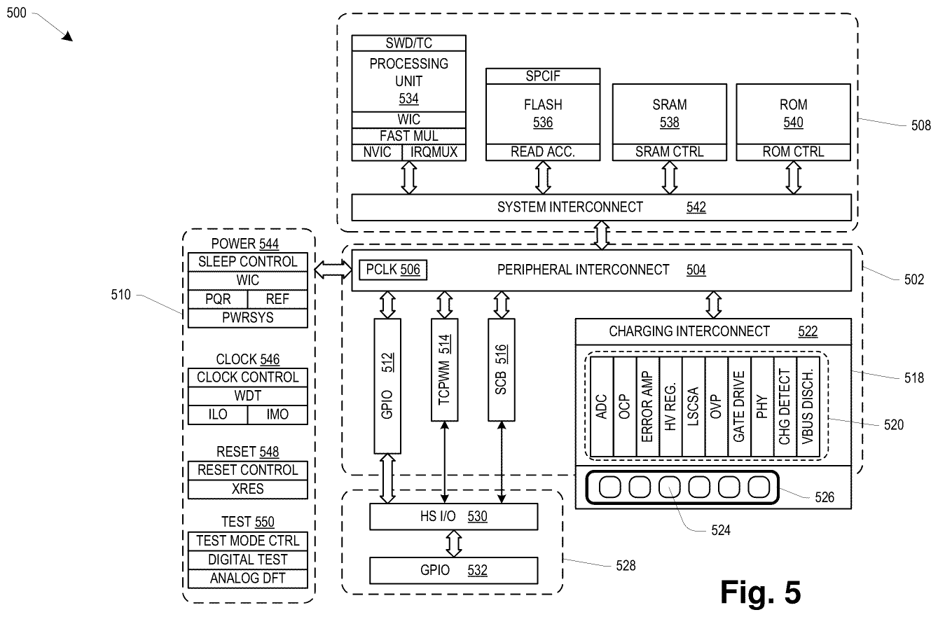

FIG. 5 is a block diagram illustrating a system 500, in accordance with some embodiments. The system 500 may be used to implement the charging controller 106 as an integrated circuit (IC) instantiated on a single semiconductor die. The system 500 may include a peripheral subsystem 502 that includes a number of components for use in wireless charging or wired USB-PD power delivery. The peripheral subsystem 502 may include a peripheral interconnect 504 including a peripheral clock module (PCLK) 506 for providing clock signals to the various components of the peripheral subsystem 502. The peripheral interconnect 504 may be a peripheral bus, such as a single level or Multi-level Advanced High Performance Bus (AHB), and can provide a data and control interface between the peripheral subsystem 502, a CPU subsystem 508, and system resources 510. The peripheral interconnect 504 may include controller circuitry, such as direct memory access (DMA) controllers, which may be programmed to transfer data between peripheral blocks without input from the CPU subsystem 508, without control of the CPU subsystem 508, or without stressing the same transfer.

The peripheral interconnect 504 may be used to couple the peripheral subsystem 502 components to other components of the system 500. A number of general purpose inputs/outputs (GPIOs) 512 may be coupled to the peripheral interconnect 504 for sending and receiving signals. The GPIOs 512 may include circuitry configured to implement various functions such as pull-up, pull-down, input threshold selection, input and output buffer enable/disable, single multiplexing, and so on. Other functions can also be implemented by the GPIOs 512. One or more timer/counter/pulse width modulators (TCPWM) 514 may also be coupled to the peripheral interconnect and may include circuitry to implement timing circuits (timers), counters, pulse width modulators (PWMs), decoders, and other digital functions associated with I/O signals work and can provide digital signals for system components of the system 500. The peripheral subsystem 502 may also include one or more Serial Communication Blocks (SCBs) 516 for implementing serial communication interfaces such as I2C, Serial Peripheral Interface (SPI), Universal Asynchronous Receiver/Transmitter (UART), Controller Area Network (CAN), CXPI (Clock Extension Peripheral Interface), etc.

The peripheral subsystem 502 may include a charging subsystem 518 (e.g., for USB-PD and/or wireless charging) coupled to the peripheral interconnect 504 and including a set of modules 520. The modules 520 may be coupled to the peripheral interconnect 504 by a charging interconnect 522. The modules 520 may include: an analog-to-digital converter (ADC) module for converting various analog signals into digital signals; an error amplifier (AMP) that regulates the output voltage on the VBUS line by PD contract; a high voltage (HV) regulator for converting the power source voltage to a precise voltage (such as 3.5-5V) to power the system 500; a low-side current sense amplifier (LSCSA) to accurately measure load current, an over-voltage protection (OVP) module and an over-current protection (OCP) module to provide over-current and over-voltage protection on the VBUS line with configurable thresholds and response times; one or more gate drivers for external power field effect transistors (FETs) (e.g., in the voltage regulator circuits 106R, 108R) in provider and consumer configurations; and a communications channel PHY module to support communications on a communication channel line (e.g., a USB Type-C configuration channel (CC) line). The modules 520 may also include a charger detection module to determine if charging circuitry is present and coupled to the system 500 and a VBUS discharge module to control the discharge of voltage on the VBUS. The VBUS discharge module may be configured to couple to a power source node on the VBUS line or to an output (power sink) node on the VBUS line and adjust the voltage on the VBUS line to the desired voltage level (i.e., the voltage level specified in the contract negotiated voltage level). The power delivery subsystem 518 may also include pads 524 for external connections and Electrostatic Discharge (ESD) suppression circuitry 526. The modules 520 may also include a communication module for retrieving and transmitting information, such as control signals.

The GPIOs 512, the TCPWM 514, and the SCB 516 may be coupled to an input/output (I/O) subsystem 528, which may include a high-speed (HS) I/O matrix 530 connected to a number of GPIOs 532. The GPIOs 512, the TCPWM 514, and the SCB 516 may be coupled to the GPIOs 532 through the HS-I/O matrix 530.

The central processing unit (CPU) subsystem 508 is provided for processing instructions, storing program information and data. The CPU subsystem 508 may include one or more processing units 534 for executing instructions and reading from and writing to memory locations from a number of memories. The processing unit 534 may be a processor suitable for operation in an integrated circuit (IC) or system-on-chip (SOC) device. In some embodiments, the processing unit 534 may be optimized for low power operation with extensive clock gating. In this embodiment, different internal control circuits can be implemented for processing unit operation in different power states. For example, the processing unit 534 may include a single wire debug (SWD) module, a terminal count (TC) module, a wake-up interrupt controller (WIC) configured to wake up the processing unit from a sleep state, which may shut down power when the IC or SOC is in is in a sleep state, a fast multiplier, a nested vector interrupt controller (NVIC), and an interrupt multiplexer (IRQMUX). The CPU subsystem 508 may include one or more memories, including a flash memory 536, a static random access memory (SRAM) 538, and a read only memory (ROM) 540. The flash memory 536 may be non-volatile memory (NAND flash, NOR flash, etc.) configured to store data, programs, and/or other firmware instructions. The flash memory 536 may include system performance controller interface (SPCIF) registers and a read accelerator and, by being integrated into the CPU subsystem 508, improve access times. The SRAM 538 may be volatile memory configured to store data and firmware instructions accessible by the processing unit 534. The ROM 540 may be configured to store boot routines, configuration parameters, and other firmware parameters and settings that do not change during operation of the system 500. The SRAM 538 and the ROM 540 may have associated control circuitry. The processing unit 534 and the memory modules 536, 538, 540 may be coupled to a system interconnect 542 to route signals to and from the various components of the CPU subsystem 508 to other blocks or modules of the system 500. The system interconnect 542 can be implemented as a system bus, such as a single-level or multi-level AHB. The system interconnect 542 may be configured as an interface to couple the various components of the CPU subsystem 508 together. The system interconnect 542 may be coupled to the peripheral interconnect 504 to provide signal paths between the CPU subsystem 508 and components of the peripheral subsystem 502.

The system resources 510 may include a power module 544, a clock module 546, a reset module 548, and a test module 550. The power module 544 may include a sleep control module, a wake-up interrupt control (WIC) module, a power-on-reset (POR) module, a number of voltage references (REF), and a PWRSYS module. In some embodiments, the power module 544 may include circuitry that allows the system 500 to draw power from and/or provide power to external sources at different voltage and/or current levels and control operation in different power states, such as active, low power, or sleep. In various embodiments, more power states may be implemented as the system 500 throttles operation to achieve a desired power consumption or power output. The clock module 546 may include a clock control module, a watchdog timer (WDT), an internal low-speed oscillator (ILO), and an internal main oscillator (IMO). The reset module 548 may include a reset control module and an external reset module (XRES module). The test module 550 may include a module to control and enter a test mode, as well as test control modules for analog and digital functions (digital test and analog DFT).

The system 500 may be implemented as an IC controller (e.g., such as the charging controller 106) in a monolithic (e.g., single) semiconductor die. In other embodiments, different parts or modules of the system 500 may be implemented on different semiconductor dies that are disposed in the same IC package.

The system 500 can be implemented in a number of application contexts. In any application context, an electronic device may have an IC controller or SOC implementation embodied by the system 500 arranged and configured to perform operations according to the techniques described herein (e.g., such as the charging controller 106). In one embodiment, the system 500 may be arranged and configured within a personal computer (PC) power adapter for a laptop, notebook computer, and so on. In an embodiment, the system 500 may be arranged and configured within a car charger configured to provide power via a magnetic charging interface and USB Type-A and/or Type-C port(s). In an embodiment, the system 500 may be arranged and configured within a power bank that can be charged via a USB Type-A and/or Type-C port and then provide power (e.g., wirelessly or via a USB port) to another electronic device.

It should be understood that a system, such as the system 500, implemented on or as an IC controller, can be placed in various applications that vary in terms of the type of power source used and the direction in which power is supplied. For example, in the case of a car charger, the power source is a car battery that provides DC power, while in the case of a mobile power adapter, the power source is an AC wall outlet. Further, in the case of a PC power adapter, the flow of power input is from a provider device to a consumer device, while in the case of a power bank, the flow of power input can be in either direction, depending on whether the power bank is operating as a power provider (e.g., to power another device) or as a power consumer (e.g., to allow itself to be charged). For these reasons, the various applications of the system 500 should be considered in an illustrative rather than a limiting sense.

According to one or more of the aspects presented herein, a charging system comprises an output port configured to operate as a Universal Serial Bus Power Delivery (USB-PD) port, a wireless charging unit comprising a magnetic charging interface that conforms to a wireless charging protocol, a voltage regulator circuit, a switch configurable to connect the voltage regulator circuit to the output port or the wireless charging unit, and a charging integrated circuit (IC) controller configured to control the switch to connect the voltage regulator circuit to the wireless charging unit and control the voltage regulator circuit to generate a magnetic charging signal at the magnetic charging interface based on a connection state of the magnetic charging interface, and control the switch to connect the voltage regulator circuit to the output port and control the voltage regulator circuit to generate a charging signal at the output port based on a connection state of the output port.

According to one or more of the aspects presented herein, the wireless charging unit comprises an inverter connected to the switch, and the charging IC controller is configured to control the switch to connect the voltage regulator circuit to the inverter, and control the inverter to generate the magnetic charging signal.

According to one or more of the aspects presented herein, the wireless charging unit comprises a visual indicator, and the charging IC controller is configured to control the visual indicator in a first state responsive to the voltage regulator circuit being connected to the output port, control the visual indicator in a second state responsive to the magnetic charging signal being generated in a full power mode, and control the visual indicator in a third state responsive to the magnetic charging signal being generated in a reduced power mode.

According to one or more of the aspects presented herein, the charging IC controller is configured to establish a first contract with one of a first device connected to the output port or a second device connected to the magnetic charging interface, and establish a second contract with the other of the first device or the second device based on power remaining after satisfying the first contract.

According to one or more of the aspects presented herein, the voltage regulator circuit is integrated into the charging IC controller.

According to one or more of the aspects presented herein, the wireless charging unit comprises a visual indicator, and the charging IC controller is configured to control the visual indicator in a first state based on the connection state of the magnetic charging interface, and control the visual indicator in a second state based on the connection state of the output port.

According to one or more of the aspects presented herein, the charging IC controller is configured to control the switch to connect the voltage regulator circuit to the wireless charging unit responsive to the connection state of the magnetic charging interface being a connected state and the connection state of the output port being a disconnected state.

According to one or more of the aspects presented herein, the charging IC controller is configured to control the switch to connect the voltage regulator circuit to a one of the output port or the wireless charging unit having a connection state transitioning from a disconnected state to a connected state.

According to one or more of the aspects presented herein, a method for operating a charging system comprises controlling, by an integrated circuit (IC) controller of the charging system, a switch to connect a voltage regulator circuit of the charging system to one of an output port of the charging system or a magnetic charging interface of a wireless charging unit of the charging system based on a connection state of the output port and a connection state of the magnetic charging interface, wherein the output port is a Universal Serial Bus Power Delivery (USB-PD) port and the magnetic charging interface conforms to a wireless charging protocol, controlling, by the IC controller, the voltage regulator circuit to generate a magnetic charging signal at the magnetic charging interface responsive to the switch being controlled to connect the voltage regulator circuit to the magnetic charging unit, and controlling, by the IC controller, the voltage regulator circuit to generate a charging signal at the output port responsive to the switch being controlled to connect the voltage regulator circuit to the output port.

According to one or more of the aspects presented herein, the wireless charging unit comprises an inverter connected to the switch, and the method comprises controlling the switch to connect the voltage regulator circuit to the inverter, and controlling the inverter to generate the magnetic charging signal.

According to one or more of the aspects presented herein, the method comprises controlling, by the IC controller, a visual indicator of the magnetic charging unit to be in a first state responsive to the voltage regulator circuit being connected to the output port, controlling, by the IC controller, the visual indicator to be in a second state responsive to the magnetic charging signal being generated in a full power mode, and controlling, by the IC controller, the visual indicator to be in a third state responsive to the magnetic charging signal being generated in a reduced power mode.

According to one or more of the aspects presented herein, the method comprises establishing, by the IC controller, a first contract with one of a first device connected to the output port or a second device connected to the magnetic charging interface, and establishing, by the IC controller, a second contract with the other of the first device or the second device based on power remaining after satisfying the first contract.

According to one or more of the aspects presented herein, the method comprises controlling a visual indicator of the magnetic charging interface to be in a first state responsive to the switch being controlled to connect the voltage regulator circuit to the magnetic charging unit, and controlling the visual indicator to be in a second state responsive to the switch being controlled to connect the voltage regulator circuit to the output port.

According to one or more of the aspects presented herein, the method comprises controlling the switch to connect the voltage regulator circuit to the wireless charging unit responsive to the connection state of the magnetic charging interface being a connected state and the connection state of the output port being a disconnected state.

According to one or more of the aspects presented herein, the method comprises controlling the switch to connect the voltage regulator circuit to a one of the output port or the wireless charging unit having a connection state transitioning from a disconnected state to a connected state.

According to one or more of the aspects presented herein, a charging system comprises an output port configured as a Universal Serial Bus Power Delivery (USB-PD) port, a voltage regulator circuit, a wireless charging unit configured according to a wireless charging protocol, the wireless charging unit comprising an inverter connected to the voltage regulator circuit, and a magnetic charging interface, and a charging integrated circuit (IC) controller configured to control the voltage regulator circuit to generate a charging signal at the output port based on a connection state of the output port, and control the inverter to generate a magnetic charging signal at the magnetic charging interface based on a connection state of the magnetic charging interface.

According to one or more of the aspects presented herein, the wireless charging unit comprises a visual indicator, and the charging IC controller is configured to control the visual indicator in a first state responsive to the connection state of the magnetic charging interface being a disconnected state, control the visual indicator in a second state responsive to the magnetic charging signal being generated in a full power mode, and control the visual indicator in a third state responsive to the magnetic charging signal being generated in a reduced power mode.

According to one or more of the aspects presented herein, the charging IC controller is configured to establish a first contract with one of a first device connected to the output port or a second device connected to the magnetic charging interface, and establish a second contract with the other of the first device or the second device based on power remaining after satisfying the first contract.

According to one or more of the aspects presented herein, the charging system further comprises a switch connected to the voltage regulator circuit, the inverter, and the output port, wherein the charging IC controller is configured to control the switch to connect the voltage regulator circuit to the output port responsive to the connection state of the output port being a connected state and the connection state of the magnetic charging interface being a disconnected state, control the switch to connect the voltage regulator circuit to the inverter responsive to the connection state of the output port being a disconnected state and the connection state of the magnetic charging interface being a connected state, and control the switch to connect the voltage regulator circuit to the output port and to connect the voltage regulator circuit to the inverter responsive to the connection state of the output port being a connected state and the connection state of the magnetic charging interface being a connected state.

According to one or more of the aspects presented herein, the wireless charging unit comprises a visual indicator, and the charging IC controller is configured to control a state of the visual indicator based on a state of the switch.

Various operations of embodiments are provided herein. In an embodiment, one or more of the operations described may be implemented as computer readable instructions stored on one or more computer readable media, which if executed by an electronic device, will cause the device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” and/or the like is used herein to mean serving as an example, instance, illustration, etc., and not necessarily as advantageous. As used herein, “or” is intended to mean an inclusive “or” rather than an exclusive “or”. In addition, “a” and “an” as used in this application can generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A charging system, comprising:
an output port configured to operate as a Universal Serial Bus Power Delivery (USB-PD) port;
a wireless charging unit comprising a magnetic charging interface that conforms to a wireless charging protocol;
a voltage regulator circuit;
a switch configurable to connect the voltage regulator circuit to the output port or the wireless charging unit; and
a charging integrated circuit (IC) controller configured to:
control the switch to connect the voltage regulator circuit to the wireless charging unit and control the voltage regulator circuit to generate a magnetic charging signal at the magnetic charging interface based on a connection state of the magnetic charging interface; and
control the switch to connect the voltage regulator circuit to the output port and control the voltage regulator circuit to generate a charging signal at the output port based on a connection state of the output port.

2. The charging system of claim 1, wherein:
the wireless charging unit comprises an inverter connected to the switch; and
the charging IC controller is configured to:
control the switch to connect the voltage regulator circuit to the inverter; and
control the inverter to generate the magnetic charging signal.

3. The charging system of claim 1, wherein:
the wireless charging unit comprises a visual indicator; and
the charging IC controller is configured to:
control the visual indicator in a first state responsive to the voltage regulator circuit being connected to the output port;
control the visual indicator in a second state responsive to the magnetic charging signal being generated in a full power mode; and
control the visual indicator in a third state responsive to the magnetic charging signal being generated in a reduced power mode.

4. The charging system of claim 1, wherein the charging IC controller is configured to:
establish a first contract with one of a first device connected to the output port or a second device connected to the magnetic charging interface; and
establish a second contract with the other of the first device or the second device based on power remaining after satisfying the first contract.

5. The charging system of claim 1, wherein:
the voltage regulator circuit is integrated into the charging IC controller.

6. The charging system of claim 1, wherein:
the wireless charging unit comprises a visual indicator; and
the charging IC controller is configured to:
control the visual indicator in a first state based on the connection state of the magnetic charging interface; and
control the visual indicator in a second state based on the connection state of the output port.

7. The charging system of claim 1, wherein:
the charging IC controller is configured to control the switch to connect the voltage regulator circuit to the wireless charging unit responsive to the connection state of the magnetic charging interface being a connected state and the connection state of the output port being a disconnected state.

8. The charging system of claim 1, wherein:
the charging IC controller is configured to control the switch to connect the voltage regulator circuit to a one of the output port or the wireless charging unit having a connection state transitioning from a disconnected state to a connected state.

9. A method for operating a charging system comprising:
controlling, by an integrated circuit (IC) controller of the charging system, a switch to connect a voltage regulator circuit of the charging system to one of an output port of the charging system or a magnetic charging interface of a wireless charging unit of the charging system based on a connection state of the output port and a connection state of the magnetic charging interface, wherein the output port is a Universal Serial Bus Power Delivery (USB-PD) port and the magnetic charging interface conforms to a wireless charging protocol;
controlling, by the IC controller, the voltage regulator circuit to generate a magnetic charging signal at the magnetic charging interface responsive to the switch being controlled to connect the voltage regulator circuit to the magnetic charging unit; and
controlling, by the IC controller, the voltage regulator circuit to generate a charging signal at the output port responsive to the switch being controlled to connect the voltage regulator circuit to the output port.

10. The method of claim 9, wherein:
the wireless charging unit comprises an inverter connected to the switch; and
the method comprises:
controlling the switch to connect the voltage regulator circuit to the inverter; and
controlling the inverter to generate the magnetic charging signal.

11. The method of claim 9, comprising:
controlling, by the IC controller, a visual indicator of the magnetic charging unit to be in a first state responsive to the voltage regulator circuit being connected to the output port;
controlling, by the IC controller, the visual indicator to be in a second state responsive to the magnetic charging signal being generated in a full power mode; and
controlling, by the IC controller, the visual indicator to be in a third state responsive to the magnetic charging signal being generated in a reduced power mode.

12. The method of claim 9, comprising:
establishing, by the IC controller, a first contract with one of a first device connected to the output port or a second device connected to the magnetic charging interface; and
establishing, by the IC controller, a second contract with the other of the first device or the second device based on power remaining after satisfying the first contract.

13. The method of claim 9, comprising:
controlling a visual indicator of the magnetic charging interface to be in a first state responsive to the switch being controlled to connect the voltage regulator circuit to the magnetic charging unit; and
controlling the visual indicator to be in a second state responsive to the switch being controlled to connect the voltage regulator circuit to the output port.

14. The method of claim 9, comprising:
controlling the switch to connect the voltage regulator circuit to the wireless charging unit responsive to the connection state of the magnetic charging interface being a connected state and the connection state of the output port being a disconnected state.

15. The method of claim 9, comprising:
controlling the switch to connect the voltage regulator circuit to a one of the output port or the wireless charging unit having a connection state transitioning from a disconnected state to a connected state.

16. A charging system, comprising:
an output port configured as a Universal Serial Bus Power Delivery (USB-PD) port;
a voltage regulator circuit;
a wireless charging unit configured according to a wireless charging protocol, the wireless charging unit comprising:
an inverter connected to the voltage regulator circuit; and
a magnetic charging interface; and
a charging integrated circuit (IC) controller configured to:
control the voltage regulator circuit to generate a charging signal at the output port based on a connection state of the output port; and
control the inverter to generate a magnetic charging signal at the magnetic charging interface based on a connection state of the magnetic charging interface.

17. The charging system of claim 16, wherein:
the wireless charging unit comprises a visual indicator; and
the charging IC controller is configured to:
control the visual indicator in a first state responsive to the connection state of the magnetic charging interface being a disconnected state;
control the visual indicator in a second state responsive to the magnetic charging signal being generated in a full power mode; and
control the visual indicator in a third state responsive to the magnetic charging signal being generated in a reduced power mode.

18. The charging system of claim 16, wherein the charging IC controller is configured to:
establish a first contract with one of a first device connected to the output port or a second device connected to the magnetic charging interface; and
establish a second contract with the other of the first device or the second device based on power remaining after satisfying the first contract.

19. The charging system of claim 16, further comprising:
a switch connected to the voltage regulator circuit, the inverter, and the output port, wherein:
the charging IC controller is configured to:
control the switch to connect the voltage regulator circuit to the output port responsive to the connection state of the output port being a connected state and the connection state of the magnetic charging interface being a disconnected state;
control the switch to connect the voltage regulator circuit to the inverter responsive to the connection state of the output port being a disconnected state and the connection state of the magnetic charging interface being a connected state; and
control the switch to connect the voltage regulator circuit to the output port and to connect the voltage regulator circuit to the inverter responsive to the connection state of the output port being a connected state and the connection state of the magnetic charging interface being a connected state.

20. The charging system of claim 19, wherein:
the wireless charging unit comprises a visual indicator; and
the charging IC controller is configured to control a state of the visual indicator based on a state of the switch.
